(19) United States
(12) Patent Application Publication
(10) Pub. No.: US 2026/0102305 A1
(43) Pub. Date: Apr. 16, 2026

(54) MODULAR HIP STRETCHING DEVICE

(71) Applicant: ERMI LLC, Atlanta, GA (US)

(72) Inventors: Jon Hartley Branch, Atlanta, GA (US); Ethan Michael DeVries, Carmel, IN (US); Benjamin Scott Clarke, Liberty Township, OH (US); Thomas P. Branch, Atlanta, GA (US)

(73) Assignee: ERMI LLC, Atlanta, GA (US)

(21) Appl. No.: 19/357,563

(22) Filed: Oct. 14, 2025

Related U.S. Application Data
(60) Provisional application No. 63/707,118, filed on Oct. 14, 2024.

(51) Int. Cl. A61H 1/02

(52) U.S. Cl. CPC A61H 1/0244

(57) ABSTRACT

A device for improving range of motion of a hip joint, includes: a base; a lower trunk support system; a leg fixing assembly connected to the base; and a target leg motion assembly connected to the base, including: a target leg holding assembly configured to hold an upper portion of a target leg of a user; a lower leg holding assembly configured to hold a lower portion of the target leg of a user, and at least one of: a flexion system configured to selectively move the target let holding assembly in an arc about a first axis; a coronal rotation system configured to selectively move the target leg holding system in an arc about a second axis; and a transverse rotation system configured to selectively move the lower leg holding system in an arc about a third axis.

### CROSS-REFERENCE TO RELATED APPLICATIONS

This application claims the benefit of U.S. Provisional Patent Application 63/707,118 filed Oct. 14, 2024, which is herein incorporated by reference in its entirety.

### TECHNICAL FIELD AND BACKGROUND OF THE INVENTION

The present invention relates to the field of orthopedic devices, specifically focusing on devices designed to restore and enhance gains in the range of motion of the hip joint.

The hip joint is a critical component of human mobility, playing a vital role in weight-bearing and dynamic movements such as walking and running. However, events such as traumatic injuries, degenerative diseases (e.g. osteoarthritis), and surgeries (e.g. hip replacements) can significantly impair the range of motion of the hip joint. This impairment can lead to reduced functionality, chronic pain, and decreased quality of life.

Different joints are capable of moving in different directions, and the full range of motion of a joint depends upon the anatomy of that joint and on the particular genetics of each individual. Joint motion can generally be classified as linear or rotational. For example, linear joint motions include flexion and extension where flexion is defined as a bending of the joint and extension is often defined as a straightening of the joint. Rotational motions of the hip joint include abduction, adduction, and internal/external rotation.

Typical rehabilitation methods involve targeted exercises and manual manipulation to improve joint mobility. These methods have significant variance in results depending on the person's commitment and compliance to the exercises suggested by a physical therapist. Certain devices exist to address these shortcomings such as continuous passive motion machines which is a motorized device that moves the hip joint back and forth in a controlled range. However, these machines fail to adequately simulate all the motions that the hip joint typically undergoes for functional activities especially rotational motions.

In view of the circumstances described above, there is a need for a system to assist in the improvement of all functional motion of the hip joint.

### SUMMARY

Embodiments of the present invention address the above needs and/or achieve other advantages by providing systems, apparatuses, and methods that assist with a device for manipulating a target leg of a user to provide functional motion of the user's hip joint. Hereinafter, “the device” refers to a device for manipulating a target leg of a user to provide function motion of the user's hip joint. The device includes a base, a lower trunk support system, a leg fixing assembly, and a target leg motion assembly.

Shortcomings of the prior art are overcome and additional advantages are provided through the provision of a device for improving range of motion of a hip joint, including: a base; a lower trunk support system connected to the base, and including a lower trunk support member; a leg fixing assembly connected to the base, and configured to restrain a non-target leg of a user; and a target leg motion assembly connected to the base and including: a target leg holding assembly configured to hold an upper portion of a target leg of a user; a lower leg holding assembly configured to hold a lower portion of the target leg of a user, and at least one of: a flexion system configured to selectively move the target leg holding assembly in an arc about a first axis to thereby produce flexion or extension in a hip joint of the user's target leg; a coronal rotation system configured to selectively move the target leg holding assembly in an arc about a second axis to thereby produce abduction or abduction in the hip joint of the user's target leg; and a transverse rotation system configured to selectively move the lower leg holding system in an arc about a third axis to thereby produce internal rotation or external rotation in the hip joint of the user's target leg.

According to some embodiments, at least one of the leg fixing assembly and the target leg motion assembly is connected to the base with a quick-release mount assembly.

According to some embodiments, the leg fixing assembly and the target leg motion assembly are each connected to the base with a quick-release mount assembly.

According to some embodiments, the flexion system includes a support member and a flexion actuator.

According to some embodiments, the coronal rotation system includes a coronal rotation platform member and a coronal rotation actuator.

According to some embodiments, the transverse rotation system includes an actuator support member and a transverse rotation actuator.

According to some embodiments, the leg fixing assembly includes at least one locking highest, at least one leg fixing support member, and a foot engagement cradle.

According to some embodiments, the leg fixing assembly extends in a horizontal direction in a use position.

According to some embodiments, the leg fixing assembly has a portion extending in a vertical direction and a portion extending in a horizontal direction.

According to some embodiments, the leg fixing assembly is configured to apply at least one of internal rotation and abduction to the user's non-target leg.

According to some embodiments, the leg fixing assembly is pivotable relative to the base about a vertical axis.

According to some embodiments, a height of the base is adjustable.

According to some embodiments, the base includes one or more telescoping legs.

According to some embodiments, the one or more telescoping legs each include a weight balancing device urging the telescoping leg towards an extended position.

According to some embodiments, at least one of the actuators is a rotary actuator.

According to some embodiments, at least one of the actuators is a hydraulic actuator.

According to some embodiments, the device further includes a power unit mounted to the base, the power unit including: a power cylinder, a pivoting pump lever, and an adjustment switch.

According to some embodiments, the device further includes a force application system mounted to the base, the power unit including: a pump, a pivoting pump lever, and an adjustment control.

According to some embodiments, the device further includes a power unit including a powered pump operably connected to the actuators through a control.

According to some embodiments, at least one of the target leg motion assembly and the leg fixing assembly is configured to pivot between a storage position and a use position.

According to some embodiments, the base has a cradle to control the lower torso by limiting at least one of: pelvic rotation, abduction/adduction, or flexion/extension with a user supine.

According to some embodiments, the base has a cradle to control the lower torso by limiting at least one of: pelvic rotation, abduction/adduction, or flexion/extension with a user standing.

According to some embodiments, the base has a cradle to control the lower torso by limiting at least one of: pelvic rotation, abduction/adduction, or flexion/extension with the patient sitting up.

According to some embodiments, the base has an extended portion that can slide under the mattress of a bed for stability.

According to some embodiments, the base has a protruding handle to allow the user to pull themselves up into a seated position.

According to some embodiments, the target leg holding assembly is attached to the base using a universal ball joint which allows three degrees of rotation of the target leg holding assembly with respect to the base.

According to some embodiments, a linear actuator causes flexion/extension rotation.

According to some embodiments, a linear actuator causes an abduction/adduction rotation.

According to some embodiments, a linear actuator causes an internal/external rotation.

According to some embodiments, the target leg cradle has a rotational actuator between the upper and lower leg at the knee that allows flexion and extension of the knee independently from any motion between the upper leg and the base.

According to some embodiments, at least one actuator of the target leg motion assembly is are coupled with a measurement system including at least one transducer operable to measure a position of the target leg motion assembly.

According to some embodiments, the measurement system includes a pressure transducer coupled to one of the actuators, where the actuator is hydraulically operated.

According to some embodiments, the measurement system is connected in data communication to a computer.

According to some embodiments, the computer is connected in data communication to a wide area network.

According to some embodiments, the leg fixing assembly is configured with a pivoting connection to permit bending of a user's knee.

The features, functions, and advantages that have been discussed may be achieved independently in various embodiments of the present invention or may be combined in yet other embodiments, further details of which can be seen with reference to the following description and drawings. Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description is read with reference to the accompanying drawings in which:

FIG. 1 illustrates the functional range of motions of the hip joint that a device can be used to restore or enhance hip motion;

FIG. 2 is a perspective view of an exemplary device for manipulating a target leg of a user;

FIG. 3 is another perspective view of the device of FIG. 2;

FIG. 4 is a top view of the device of FIG. 2;

FIG. 5 is a left side view of the device of FIG. 2;

FIG. 6 is a right side view of the device of FIG. 2;

FIG. 7 is an enlarged perspective view of a portion of the device of FIG. 2;

FIG. 8 is an exploded view of a portion of FIG. 7;

FIG. 9 is a view showing the device of FIG. 2 adjusted for a minimum height;

FIG. 10 is a view showing the device of FIG. 2 adjusted for a maximum height;

FIG. 11 is a partially-sectioned view of a leg of the device of FIG. 2;

FIG. 12 is a view showing the device of FIG. 2 adjusted for a minimum leg length;

FIG. 13 is a view showing the device of FIG. 2 adjusted for maximum leg length;

FIG. 14 is a view showing the device of FIG. 2 adjusted to a minimum width;

FIG. 15 is a view showing the device of FIG. 2 adjusted to a maximum width;

FIG. 16 is a view showing a target leg motion assembly in a maximum internal rotation position;

FIG. 17 is a view showing a target leg motion assembly in a maximum external rotation position;

FIG. 18 is a view showing a target leg motion assembly in a maximum abduction position;

FIG. 19 is a view showing a target leg motion assembly in a maximum adduction position;

FIG. 20 is a view showing a target leg motion assembly in a maximum flexion position;

FIG. 21 is a view showing a target leg motion assembly in a maximum extension position;

FIG. 22 is a perspective view showing the device in a storage position;

FIG. 23 is a diagram of a force application system suitable for use with the device of FIG. 2 for manipulating a target leg of a user;

FIG. 24 is a view of a manually-operated force application unit;

FIG. 25 is a diagram of a power unit;

FIG. 26 is a view of a control unit;

FIG. 27 is a schematic diagram of a measurement system for use with the device;

FIG. 28 is a schematic side view of an alternative leg fixing assembly;

FIG. 29 is a view of an alternative device including an actuator for knee flexion;

FIG. 30 is a view of a trunk support member including a cradle for supporting a user's pelvis;

FIG. 31 is a side view of an alternative target leg motion assembly;

FIG. 32 is an end view of the target leg motion assembly of FIG. 31; and

FIG. 33 is a bottom view of the alternative target leg motion assembly of FIG. 31.

### DETAILED DESCRIPTION

Embodiments of the present invention will now be described more fully hereinafter with reference to the accompanying drawings, in which some, but not all, embodiments of the invention are shown. Indeed, the invention may be embodied in may different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related component.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

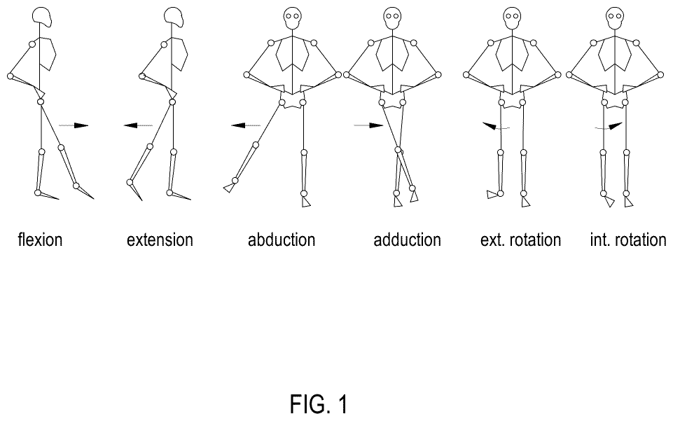

Referring now to FIG. 1, the key motions and movements meant to be enhanced and restored by the present invention are depicted. While devices exist to enhance and restore flexion and extension of a user's hip joint, other key functional motions are often neglected or ignored. Specifically, the rotation in the user's coronal plane (abduction and adduction) and transverse rotation of the user's hip joint (external and internal rotation). The present invention addresses these neglected functional movements which are key to recovery of functional operation of the hip and legs following injury or disease.

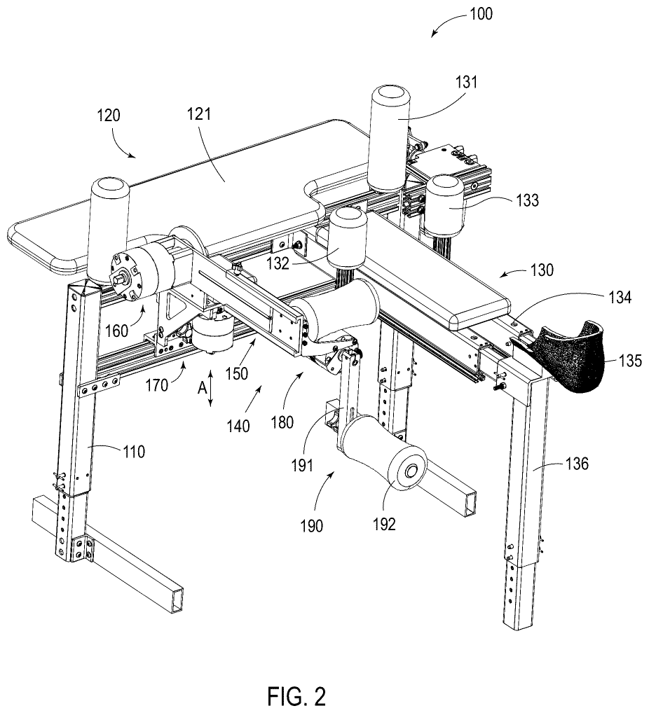

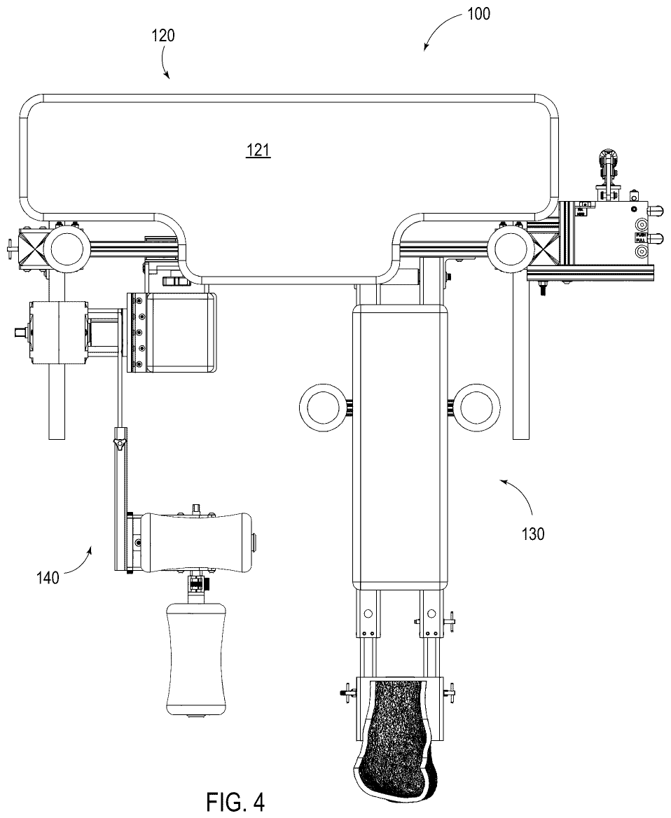

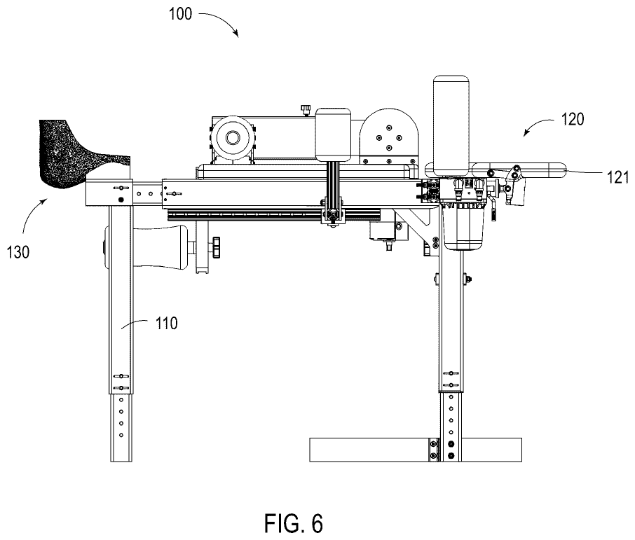

Referring now to FIGS. 2-6, exemplary embodiments of a hip range of motion improvement and enhancement device 100 is illustrated according to one embodiment of the present invention. It should be noted that as used herein the hip range of motion improvement and enhancement device may be simply referred to as “the device”. As shown, the device 100 generally includes a base 110, a lower trunk support assembly 120, a leg fixing assembly 130, and a target leg motion assembly 140. Thus, disclosed herein are various embodiments of a device 100 for manipulating a target leg of a user to provide functional range of motion improvements and enhancements while fixing the user's non-target leg that are suitable for implementing various of the elements of the methods, steps, instructions, and the like discussed herein. However, the following discussion is equally applicable to other suitable configurations of devices and components thereof (e.g. the base 110, the lower trunk support assembly 120, the leg fixing assembly 130, the target leg motion assembly 140). Generally, the lower trunk support assembly 120, the leg fixing assembly 130, and the target leg motion assembly 140 are coupled to the base 110.

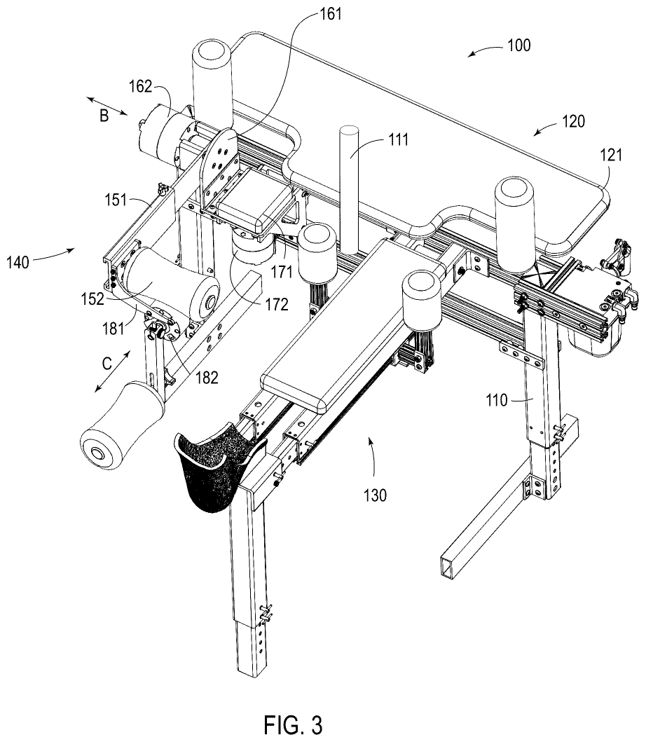

The base 110 may include means for allowing patient to support themselves when mounting or dismounting the device 100, such as handles, bars, or rails. One example is shown in FIG. 3 which illustrates an upright handle 111 extending from the base 110 between the target leg motion assembly 140 and the leg fixing assembly 130. The handle 111 may be fixed, removable, retractable, or folding.

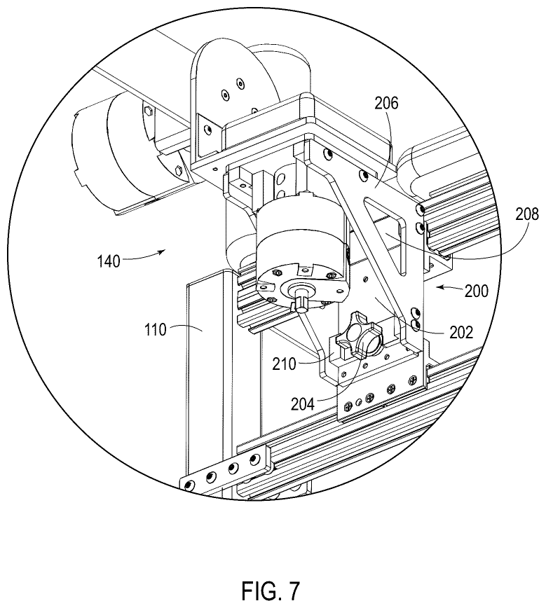

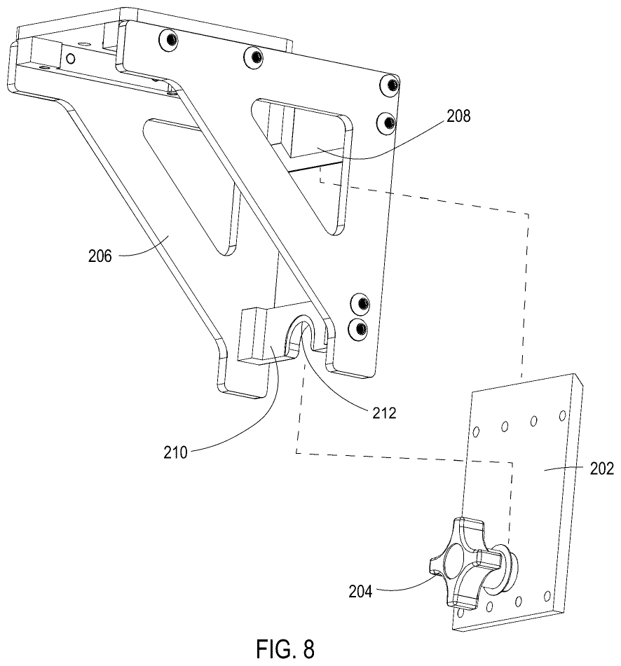

The target leg motion assembly 140 is coupled to the base 110. As seen in FIGS. 7 and 8, it may be coupled to the base 110 with a quick-release mount assembly 200, enabling it to be easily removed and reattached as a unit. The mount assembly 200 includes a mounting plate 202 mounted to the base 110. The mounting plate 202 has a clamp bolt 204 coupled thereto. The mount assembly 200 also includes a frame 206 which supports the target leg motion assembly 140. The frame 206 has upper and lower brackets 208, 210 respectively. The upper bracket 208 is shaped and sized to engage the upper edge of the mounting plate 202. For example, the upper bracket 208 and the mounting plate 202 may have complementary beveled edges, and similar to a “French cleat”. The lower bracket 210 has a recess 212 which is slotted to fit over the clamp bolt 204. The target leg motion assembly 140 may be removed by loosening the clamp bolt 204 and lifting it away from the mounting plate 202. Conversely, the target leg motion assembly 140 may be installed by engaging the brackets 208, 210 with the mounting plate 202 and over the clamp bolt 204, and tightening the clamp bolt 204.

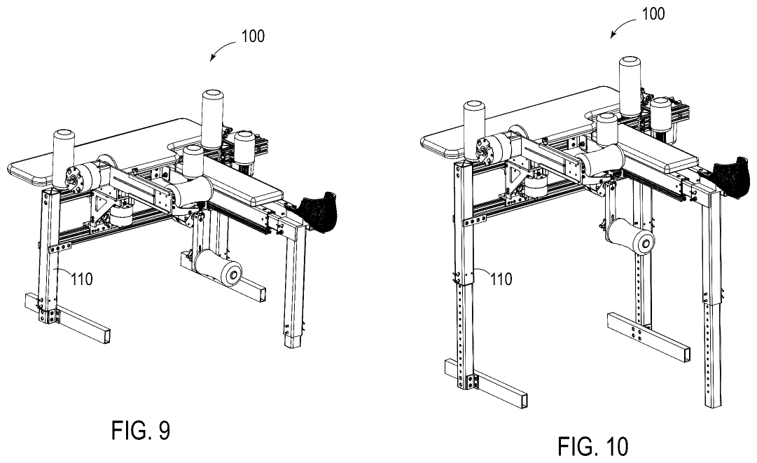

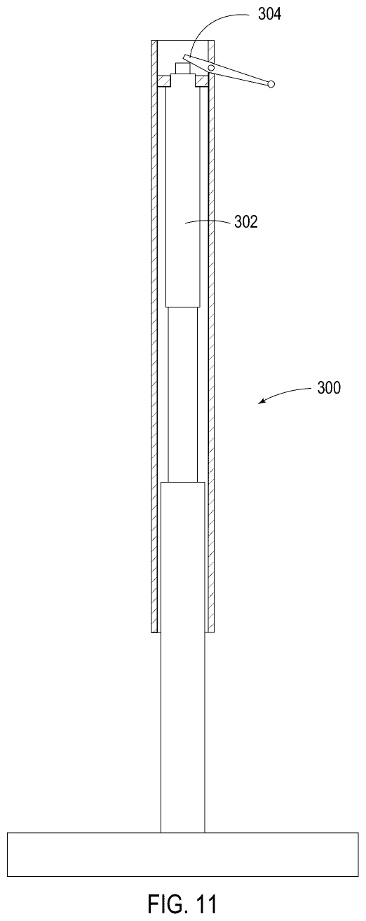

As shown in the illustrated embodiments, the base 110 includes at least one rigid frame member and is configured to provide support and stability during operation and storage of the device 100. The base 110 may be adjustable so that the device 100 can be used and aligned with the height of treatment tables or beds or varying heights. FIG. 9 shows the device 100 at a minimum height, and FIG. 10 shows the device 100 at a maximum height. In the illustrated example, the height of the base 110 is adjustable by incorporating telescoping legs. The inner and outer members of the telescoping legs include an array of holes through which fasteners (e.g., bolts, screws, or pins) may be placed. Alternatively, as shown in FIG. 11, the base 110 may be supported with one or more telescoping legs 300 each including a pressurized or spring-loaded cylinder 302, with a release control 304, and a known type. Activating the release control 304 causes the cylinder 302 to extend towards its maximum height (in the absence of a load). In the presence of a load, cylinder 302 will shorten when the release control 304 is activated. Deactivating the release control 304 will cause the cylinder 302 to remain at the selected height. This cylinder 302 provides a counter-balance of the weight of the device 100, to make it easier to adjust the height. Alternatively, the base 110 may be constructed at a fixed a height equal or around the height of a standard treatment table or residential bed. In this way, the device 100 may be pushed to the end of the standard treatment table or bed and the user can rest much of their body thereon.

The lower trunk support assembly 120 may include a trunk support member 121 configured to provide upward support to the lower portion of the user's back/abdomen and upper portion of the user's pelvis. The trunk support member 121 may include a soft material to enhance the user's comfort during operation of the device 100. The trunk support member 121 is coupled to the base 110. Alternatively, the device 100 may have no lower trunk support assembly 120 and the upward support is provided by a treatment table or bed. In other embodiments, the lower trunk support member 121 is pivotally mounted to the base 110 and configured to fold down against the base to reduce the size of the device 100 during storage and fold out to provide support to the user during operation.

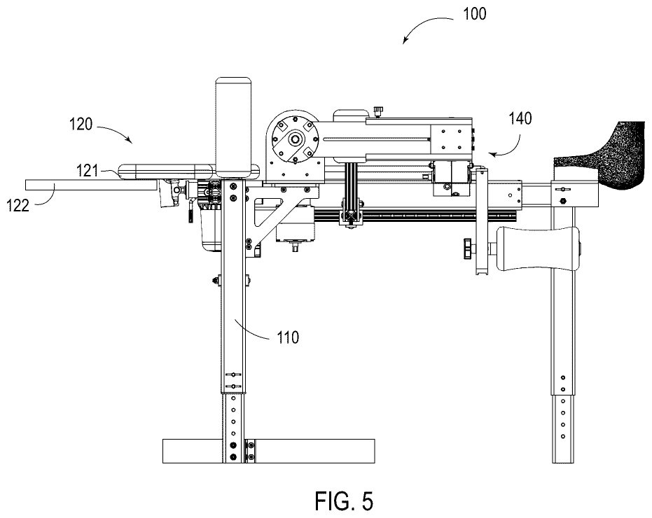

Optionally, the lower trunk support assembly 120 (or the base 110) may include a stabilizing member, such as a bar or plate, extending outward from the posterior aspect of the device. An example stabilizing member is labeled 122 in FIG. 5. This component can extend under the mattress of a user's bed to provide further stability to the device 100 when in use. The stabilizing member 122 may be fixed, removable, retractable, or folding.

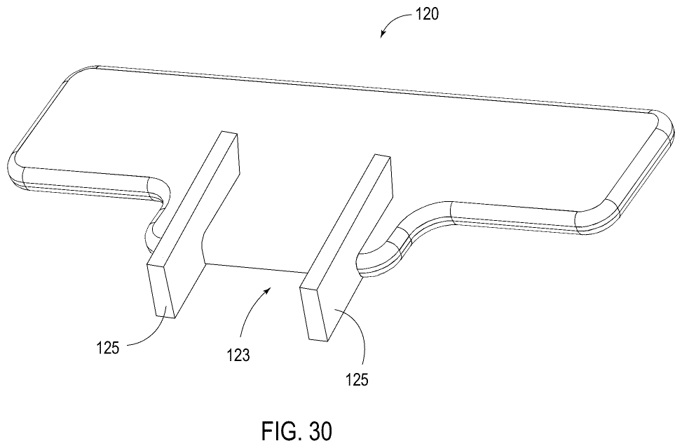

Optionally, the lower trunk support assembly 120 may incorporate a seat or cradle 123 (FIG. 30) for the purpose of controlling the lower torso by limiting pelvic rotation, abduction/adduction, or flexion/extension. In the illustrated example this is implemented by providing a pair of spaced-apart upstanding bolsters 125. This structure can be effective in supine, seated, or standing positions. Optionally, the seat or cradle may include a restraint similar to a seat belt.

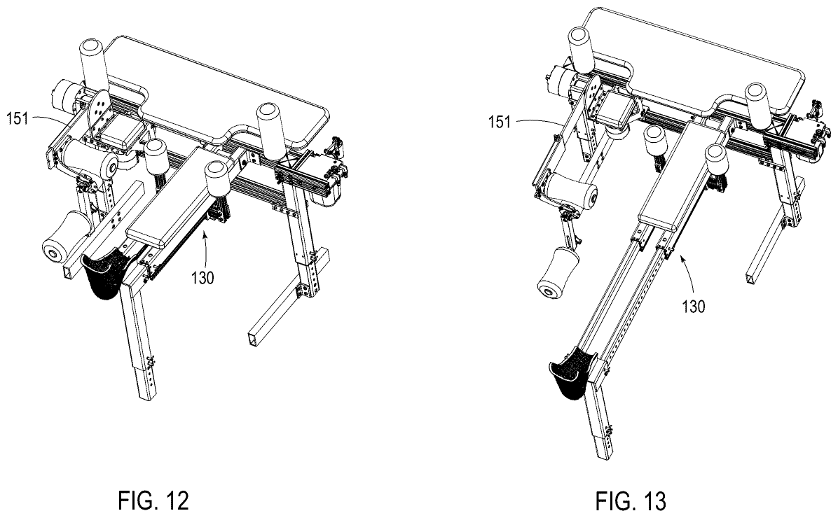

The leg fixing assembly 130 may include a plurality of locking posts (e.g., as depicted there are at least three locking posts 131-133), at least one leg fixing support member 134 and a foot engagement cradle 135. The at least one leg fixing support member 134 has a proximal end and a distal end, with the proximal end being positioned proximate the locking posts and the distal end being located at the foot engagement cradle 135. The at least one leg fixing support member 134 may be constructed from a rigid material and the upper surface may include a soft padding to increase the comfort of the user's non-target leg during operation. The proximal end of the at least one leg fixing support member 134 is coupled onto the base 110. The distal end of the at least one leg fixing support member 134 extends from the proximal end in the direction of the user's foot near the foot engagement cradle 135. The at least one leg fixing support member 134 may feature a mechanism to adjust its length depending on the length of the non-target leg of the user. FIG. 12 shows the leg fixing assembly 130 adjusted for a minimum leg length, and FIG. 13 shows the leg fixing assembly 130 adjusted for a maximum leg length.

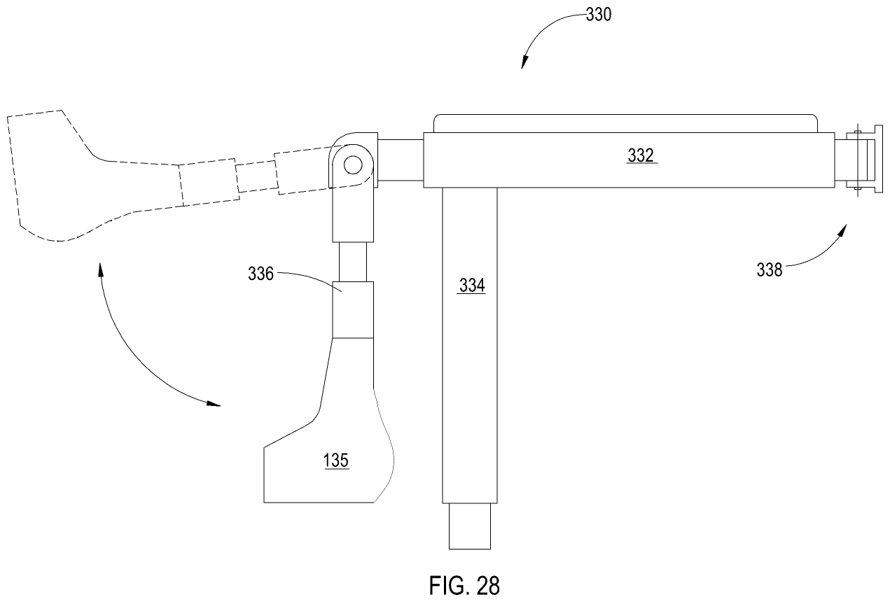

While the leg fixing assembly 130 is depicted as extending horizontally in the straight line, other configurations are possible. For example, the leg fixing support member 134 may extend partially in a horizontal direction and partially in a vertical direction, in an L-shape, with horizontal and vertical segments. The foot engagement cradle 135 may be mounted to the vertical segment. This would permit the user to position their non-target leg with their knee in a flexed position, similar to being seated in a chair. An example leg fixing assembly 330 incorporating this function is shown in FIG. 28. It includes a horizontal support member 332 and a vertical support member 334 which may be height-adjustable. A calf support 336 is pivotally coupled to the distal end of the horizontal support member 332. As shown, it can benefit through a range of approximately 90°, allowing the user's leg be supported in a position of full kneed extension, full knee flexion, or any position in between. Means may be provided for locking the pivot joint the desired position, such as a clamp, friction member, latch, or pinned (not shown). The length of the calf support 336 may be adjustable. A foot engagement cradle 135 may be coupled to a distal end of the calf support 336.

It is noted that the leg fixing assembly 130 may incorporate dimensions, adjustments, or movement functions for the purpose of securely immobilizing the non-target leg. For example, the foot engagement cradle 135 may be positioned off-center relative to the user's leg, so as to produce a small degree of internal rotation. Alternatively or in addition, may be configured to extend in a direction non-parallel to the target leg motion assembly 140, such that it can force the user's leg in a slightly lateral direction (i.e. slight abduction). This may be accomplished by including a vertical pivot axis in the leg fixing assembly. As shown in FIG. 28, a bracket 338 for attaching the leg fixing assembly to the base 110 may be provided with a vertically-oriented pivot axle 340. A clamping mechanism (not shown) may be provided to retain the leg fixing assembly in the adjusted position.

Alternatively, the at least one leg fixing support member 134 may be manufactured specifically to be fixed for the leg length of one user. The at least three locking posts 131-133 may be constructed from a rigid material and are configured to inhibit motion in the user's non-target leg and pelvis due to any discomfort during operation of the device 100. The at least three locking posts 131-133 may also include a soft material (e.g., padding) to enhance the user's comfort during operation of the device 100. The first locking post 131 is coupled to the base and may be positioned on the lateral side of the user's hip and extends in the anterior direction of the user. The first locking post 131 may be configured to inhibit any movement of the user's non-target hip. The second locking post 132 is coupled to the at least one leg fixing support member 134 and positioned on the medial side of the user's thigh and extends in the anterior direction of the user. The second locking post 132 may be configured to inhibit any movement of the non-target leg in the medial direction of the user. The third locking post 133 is coupled to the at least one leg fixing support member 134 and is positioned on the lateral side of the user and extends in the anterior direction of the user. The third locking post 133 may be configured to prevent any movement of the non-target leg in the lateral direction. The foot engagement cradle 135 is coupled to the distal end of the at least one leg fixing support member 134 and may be configured to securely hold the user's foot at a medial angle to inhibit any rotation of the user's non-target leg. Additionally, the leg fixing assembly 130 may include an upward support member 136 positioned at the distal end of the at least one leg fixing support member 134 to provide upward support to the at least one leg fixing support member 134.

Referring back to FIGS. 2 through 6, The target leg motion assembly 140 may include a target leg holding assembly 150, a flexion system 160, a coronal rotation system 170, and a transverse rotation system 180. The coronal rotation system 170 is configured to induce rotation in the coronal plane, i.e. about axis “A”, and may include a coronal rotation platform member 171 and a coronal rotation actuator 172. The coronal rotation platform member 171 is coupled to the base 110 and may be configured to provide upward support to a portion of the user's hamstring on the target leg. The coronal rotation actuator 172 is coupled onto the underside of the coronal rotation platform member 171 and configured to induce rotation in the coronal plane of the user's hip of their target leg. Specifically, the coronal rotation actuator 172 induces or otherwise causes the user's target leg to move medially or laterally thereby causing hip rotation along the coronal plane (i.e., abduction or adduction). In the illustrated example, the coronal rotation actuator 172 is a rotary actuator such as a rotary hydraulic actuator, which directly produces rotary motion when provided with pressurized fluid flow. Other types of actuators configured to produce rotation may be substituted, such as pneumatic or electrical rotary actuators, or electric motors. Alternatively, other types of actuators such as a linear actuator or hydraulic or pneumatic cylinder coupled to a crank, may be used to produce rotational motion.

As shown in the illustrated embodiments, the target leg holding assembly 150 includes a target leg support 151 and a target leg cradle 152. The target leg support 151 has a proximal end pivotally coupled to the coronal rotation platform member 171 and a distal end extending in the direction of the user's knee on the target leg. The target leg support 151 may feature a mechanism to adjust the distance between the proximal and distal ends such that various motion inducing configurations may be used. FIG. 12 shows the target leg support 151 adjusted for a minimum leg length, and FIG. 13 shows the target leg support 151 adjusted for a maximum leg length.

The target leg cradle 152 is coupled to the distal end of the target leg support 151. Collectively, the target leg cradle 152 and target leg support 151 are configured to bear against or provide support to an upper portion of a user's target leg. The target leg cradle 152 may take the form of a post. The target leg cradle 152 may also include a soft padding to provide comfort to the posterior side of the user's target leg. Optionally, a means for securing the target leg to the target leg cradle 152 may be provided. For example, an adjustable strap (not shown) may be connected to the target leg cradle 152.

The flexion system 160 is configured to induce motion in the anterior and posterior direction, or stated another way, to induce rotation in the coronal plane, i.e. about axis “B”, and may include a support member 161 and flexion actuator 162. The support member 161 may be coupled to the coronal rotation platform member 171. The flexion actuator 162 has one portion coupled to the support member 161 and one portion coupled to the target leg support 151. The flexion actuator 162 is configured to induce motion or otherwise move the target leg in the anterior and posterior direction of the user. In the illustrated example, the flexion actuator 162 is a rotary actuator such as a rotary hydraulic actuator, which directly produces rotary motion when provided with pressurized fluid flow. Other types of actuators configured to produce rotation may be substituted, such as pneumatic or electrical rotary actuators, or electric motors. Alternatively, other types of actuators such as a linear actuator or hydraulic or pneumatic cylinder coupled to a crank, may be used to produce rotational motion.

In the illustrated embodiments, the transverse rotation system 180 is configured to induce transverse rotation of the user's hip joint (i.e., internal or external rotation of the hip), i.e. about axis “C”, and may include a transverse rotation actuator support member 181, a transverse rotation actuator 182 (e.g., a rotary actuator), and a lower leg holding assembly 190. The transverse rotation actuator support member 181 has a proximal end mounted to the lower leg support 152. The transverse rotation actuator 182 is mounted to the distal end of the transverse rotation actuator support member 181 and configured to rotate lower leg holding assembly 190 comprising a leg pressure bar 191. A leg post 192 extends from a distal end of the leg pressure bar 191. The leg post 192 may be made of a rigid material. The leg post 192 may be padded with a soft material to enhance the user's comfort during transverse motion. During transverse motion, the leg post 185 is configured to push and pull the user's lower leg in the desired transverse motion direction. The subsystems described above of the device 100 may be used in different configurations in order to induce functional movements of the user's hip joint.

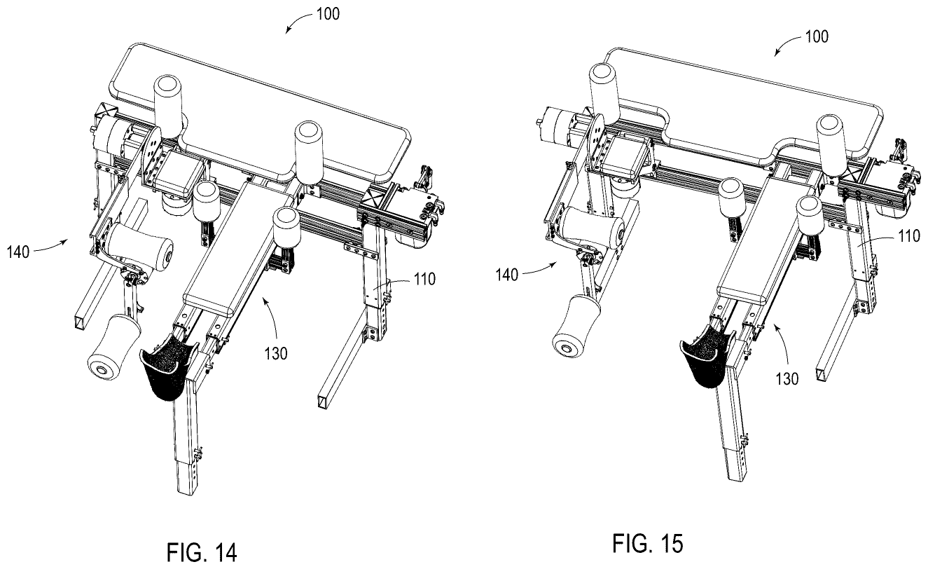

The device 100 is modular and reconfigurable for use with different users. Either or both of the target leg motion assembly 140 and the leg fixing assembly 130 may both be adjustable in a lateral direction relative to the base 110 in order to adjust the overall width of the device 100. FIG. 14 shows the device 100 at a minimum width and FIG. 15 shows the device 100 at a maximum width. This may be accomplished, for example, by mounting that target leg motion assembly 100 and the leg fixing assembly 130 to the base 110 using sliding brackets.

The device 100 may be reconfigured for use with the right leg or the left leg of the user. In the illustrated example, the target leg, that is the leg to be treated, would be the user's right leg. In order to use the device with the user's left leg, the positions of the target leg motion assembly 140 and the leg fixing assembly 130 would be interchanged. This may be done by disconnecting the individual assemblies from the base 110 and reconnecting them in different positions. It should be noted that each of the target leg motion assembly 140 and the leg fixing assembly 130 may be coupled to the base 110 using a quick-release mount assembly 200 as described above.

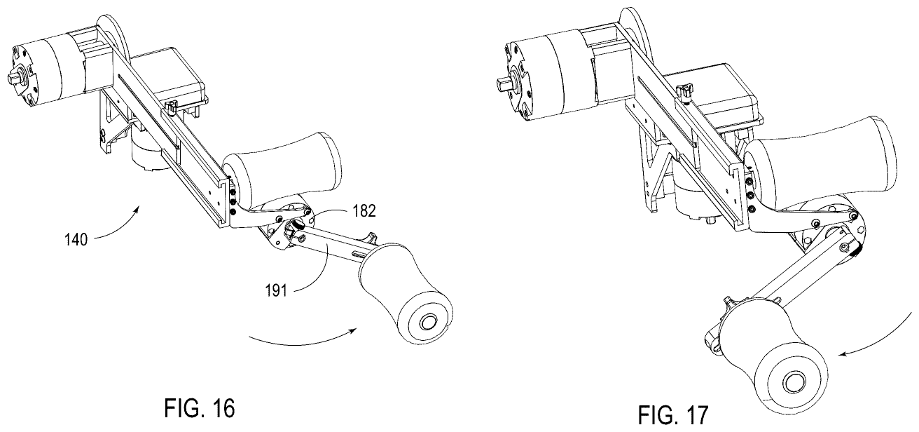

As shown in FIGS. 16-17, the length of the target leg support 151 may be adjusted such that the target leg cradle 152 provides upward support to the user's instrument hamstring and the knee of the target leg is allowed to bend. The lower portion (e.g. calf) of the target leg may be placed against the leg post 185. In FIG. 16, the leg pressure bar 191 is rotated via the transverse rotation actuator 182 to induce internal rotation of the hip joint of the user's target leg. In FIG. 17, the leg pressure bar 191 is rotated via the transverse rotation actuator 182 to induce external rotation of the hip joint of the user's target leg.

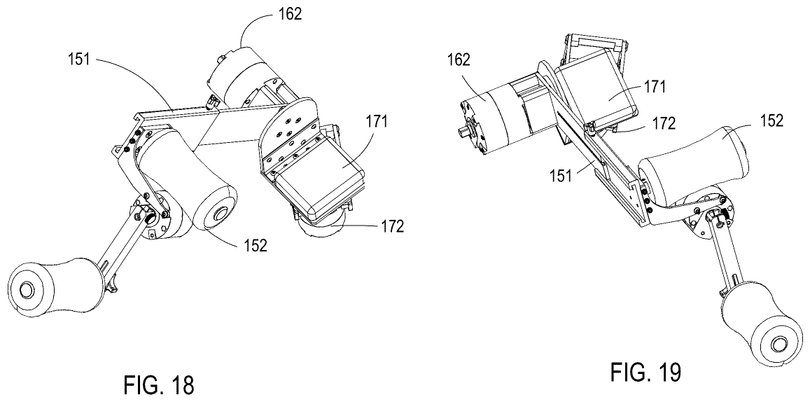

As shown in FIGS. 18-19, the target leg support 151 may be adjusted such that the target leg cradle 152 provides upward support to the user's lower hamstring and the knee of the target leg is allowed to bend. The pivotally coupled target leg support 151 may also be configured via the flexion actuator 162 such that the upper leg has a slight angle in the anterior direction. In FIG. 18, the coronal rotation actuator 172 induces a lateral rotation in the coronal plane of the coronal rotation platform member 171. This rotation causes the hip joint to undergo abduction. In FIG. 19, the coronal rotation actuator 172 induces a medial rotation in the coronal plane of the coronal rotation platform member 171. This rotation causes the hip joint to undergo adduction.

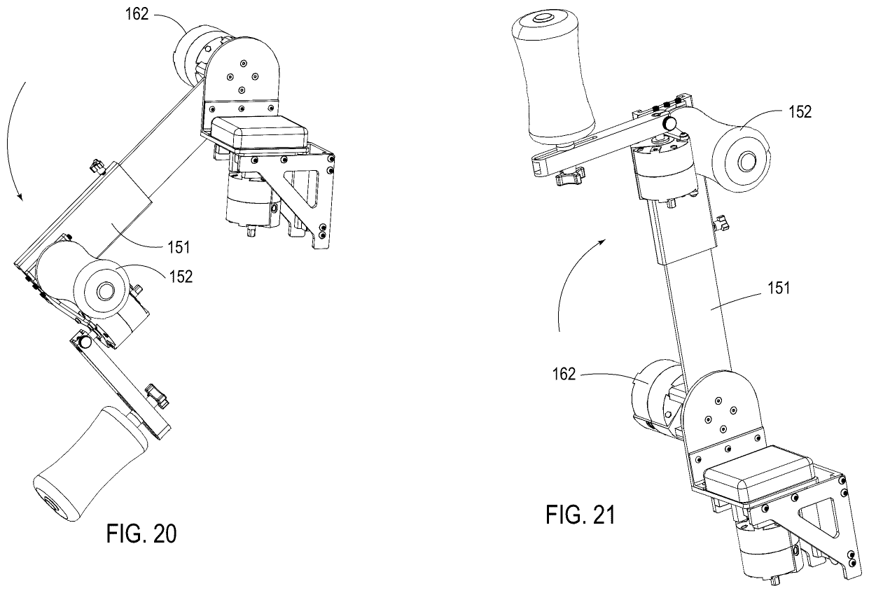

As shown in FIGS. 20-21, the length of the target leg support 151 may be adjusted such that the target leg cradle 152 provides upward support to just below the user's knee.. In FIG. 20, the flexion actuator 162 induces flexion of the hip joint of the target leg of the user. In FIG. 21, the flexion actuator 162 induces extension of the hip joint of the target leg of the user.

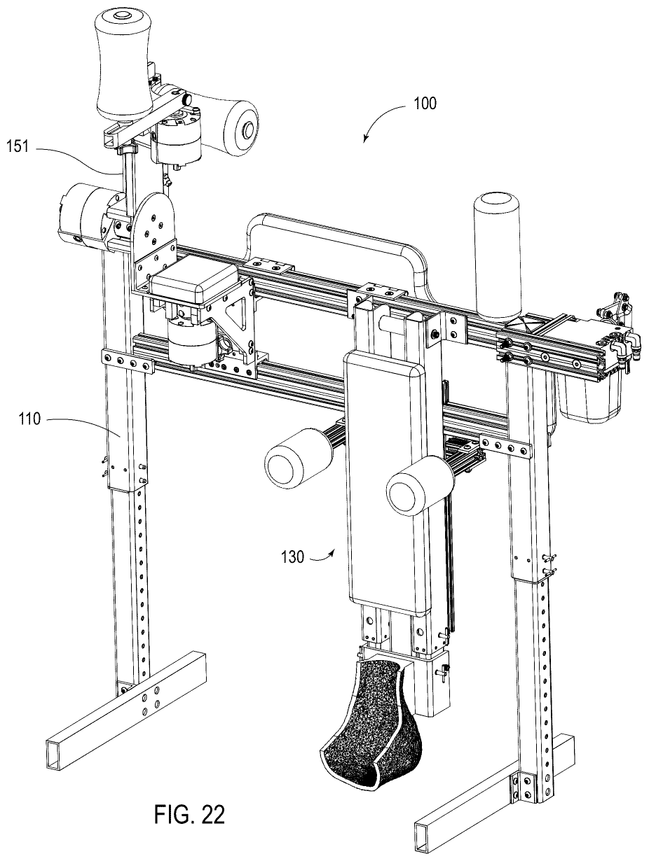

In some embodiments, components and subsystems of the device 100 can fold onto the base 110 such that the overall size of the device 100 is reduced for ease of storage. In FIG. 22 the pivotally coupled target leg support 151 and the leg fixing assembly 130 are retracted and/or folded to reduce the dimensions of the device 100. This would allow the storage of the device 100 in an office or home closet.

The device 100 may be provided with suitable power sources and controls for selectively operating the actuators 162, 172, and 182. Nonlimiting examples of suitable power sources include electrical power, pneumatic power, mechanical power, and pneumatic power.

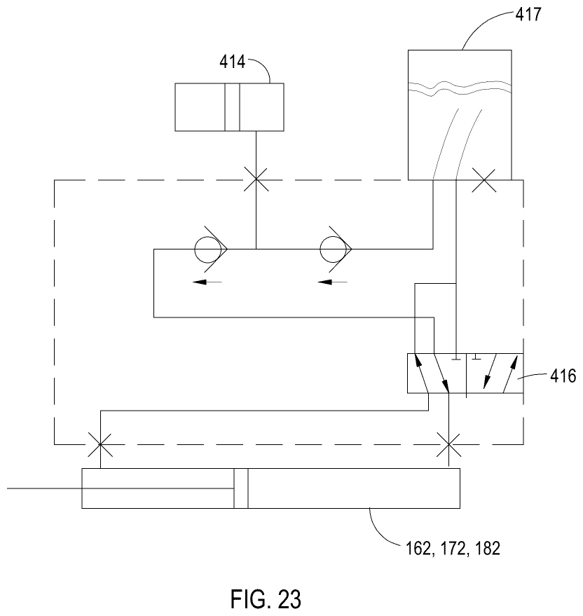

In one example, the actuators may be hydraulically powered. FIG. 23 illustrates an example of a force application system 14 that may be used to selectively provide pressurized fluid flow to the actuators.

The system includes a pump 414, a reservoir 417, and a control valve 416. It will be understood that the operating components of the force application system 14 are connected to each other and to the appropriate actuator using conduits such as pipes or hoses, shown schematically in FIG. 23.

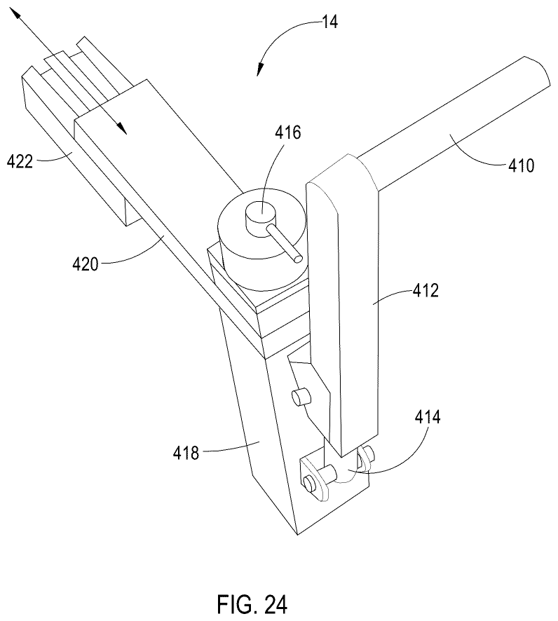

Referring to FIG. 24, the force application system 14 may further include a power unit support structure 418, 420, 422, a pivoting pump lever 412, a hand grip 410, the pump 414 is positioned such that reciprocating pivoting of the lever 412 causes a pumping action to the power cylinder 414 such that the mechanical energy of the user operating the lever 412 is converted to hydraulic energy by the pump 414. Such pumping causes fluid pressurized within the pump 414 to transfer fluid pressure to one of the actuators. In one example, the force application system may include a selector valve (not shown) operable to direct fluid flow to a selected one of the actuators 162, 172, or 182. In an alternative embodiment, the separate force application system 14 may be provided for each of the actuators An adjustment control 416 is positioned on the power unit support structure 418, 420, 422. The control 416 changes the direction of operation for the actuator such that the user can select the desired therapeutic motion. In an alternative embodiment the power unit assembly 14 is configured such that a user can engage with the pump 414 using a foot lever. This enables a user to utilize a foot instead of an opposite hand for controlling the power and working cylinders. In other alternative embodiments the power unit assembly 14 utilizes a different type of system to generate the required energy for moving the device. For example the power unit 14 may be a mechanical device having a series of gears providing a mechanical advantage based on the gearing.

During operation, a user may manually operate, e.g., using their hand, the lever 412, which can control the force generator through one or more of the actuators 162, 172, 182 and cause the leg of the user to move in a specific direction depending upon the settings of the device. If the user moves the lever 412, then this causes the actuator to exert a force on the appropriate portions of the device 100 Once activated, the actuators apply force causing the hip to rotate in the desired direction. If the hip movement is painful or otherwise uncomfortable, the user can control how much force is applied, using the lever 412, to reduce the amount of pressure. Thus, the user has full control over the amount of pressure and force applied to the hip based on lever movement.

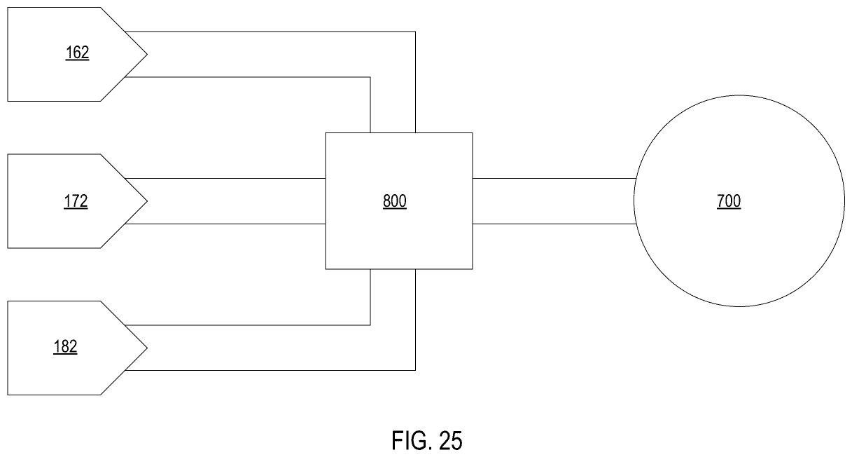

Alternatively, a powered power unit may be substituted for the manually-operated device. FIG. 25 illustrates a schematic example in which a force generator 700 is selectively coupled to the actuators 162, 172, 182 through a control unit 800. The actuators are coupled to the control unit 800 with two fluid lines each, permitting bidirectional flow of pressure and return fluid. The force generator 700 may include at least one of a pressure source, a pump, a compressor, a hydraulic pump, a hydraulic compressor, a pneumatic pump, a pneumatic compressor, suitably configured rotors and turbines, or an electric power source.

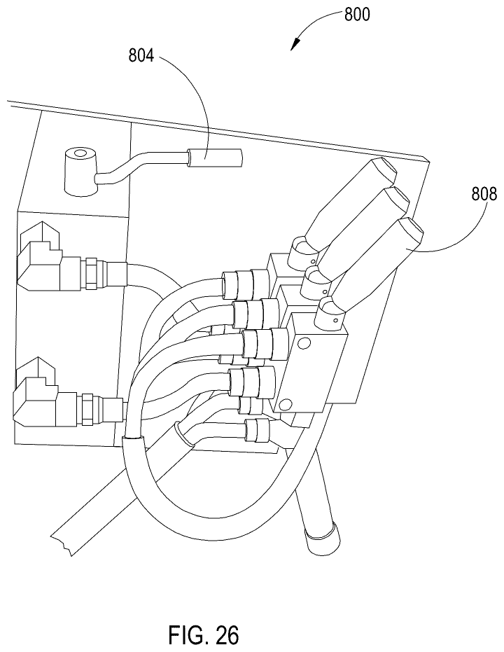

FIG. 26 illustrates an example of one possible control unit 800 that includes a forward-reverse control 804 and three actuator on-off controls 808. These controls may be direct acting valves or may be switches that operate valves remotely. The control on-off controls 808 determine whether each particular actuator is on or off. They may be proportional controls. In such an embodiment, only one actuator may be on at a time.

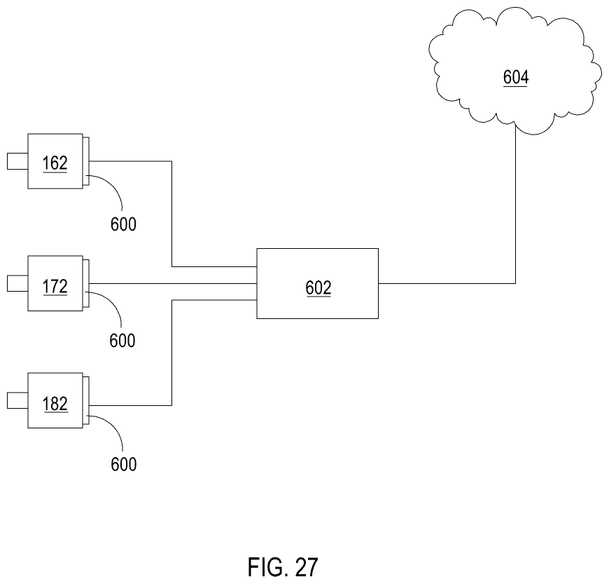

The device 100 may be equipped with various sensors and/or measurement devices for quantifying its operation. For example, the position, deflection, force, velocity, or acceleration of the movable components may be measured. Referring to FIG. 27, one example of a possible measurement system is shown. Each actuator 162, 172, 182 is equipped with a transducer or group of transducers 600 operable to measure its position, displacement, velocity, acceleration, and/or force. One example of a suitable transducer is a rotary encoder or resolver, optionally combined with a strain gage. Another example of a suitable transducer is a pressure transducer coupled to one of the actuators 162, 172, or 182 (where the actuator is hydraulic). The output of the transducers 600 may be communicated to a computer 602, over a wired or wireless connection. The computer 602 may be used to collect, store, analyze, and/or transmit data. The data may be transferred over a network 604 such as a local area network, wide area network, or the Internet. A group of interconnected computers of this type is sometime referred to as “the cloud”.

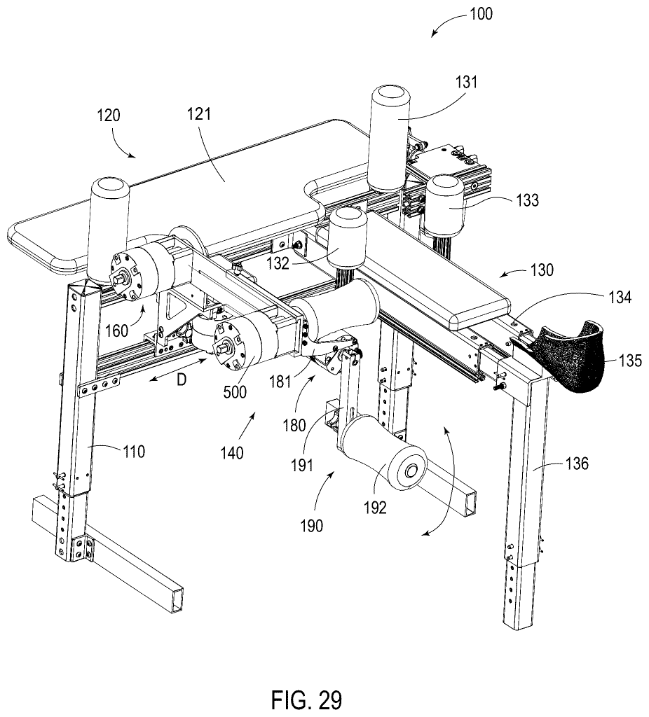

Independent of any of the movements described above, the target leg motion assembly 140 may be equipped with means for causing flexion or extension of the user's knee. Referring to FIG. 29, an example is shown in which an actuator 500 is mounted to the distal end of the target leg support 151. The actuator 500 is configured to rotate the transverse rotation actuator support member 181 with the attached leg pressure bar 191 and leg post 192 in an arc about an axis “D”. This will induce flexion or extension in the knee. A strap (not shown) or other retention member may be provided to secure the lower leg to the leg post during this procedure.

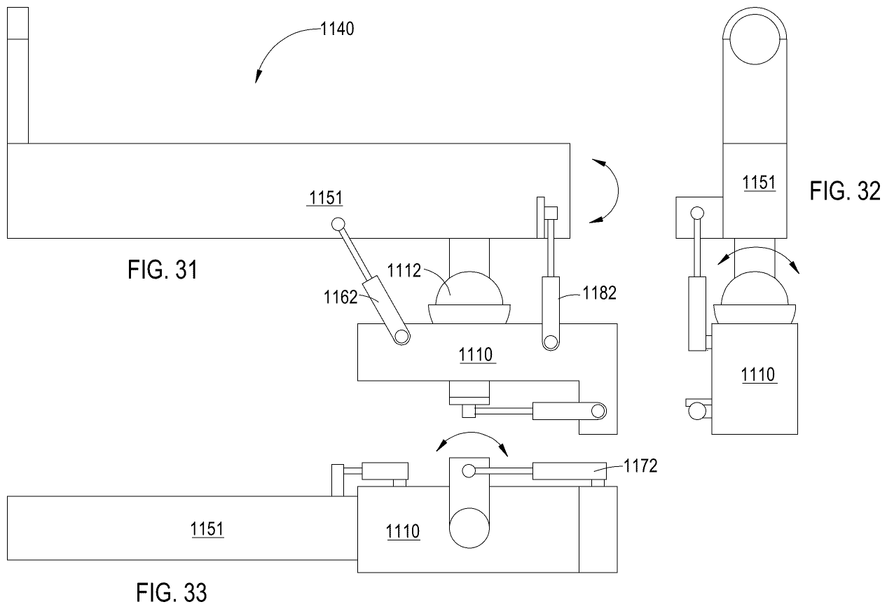

As noted above, various types of actuators may be used to produce rotational motion. FIGS. 31-33 illustrate one potential example of a target leg motion assembly 1140 that may be substituted for the assembly 140. It includes a target leg holding member 1151 mounted to a frame 1110 via a ball joint 1112 or similar structure with three degrees of freedom. Three linear actuators 1162, 1172, and 1182 are provided and configured to produce extension/flexion, abduction/adduction, and internal rotation/external rotation, respectively.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims. The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A device for improving range of motion of a hip joint, comprising:
a base;
a lower trunk support system connected to the base, and including a lower trunk support member;
a leg fixing assembly connected to the base, and configured to restrain a non-target leg of a user; and
a target leg motion assembly connected to the base and including:
a target leg holding assembly configured to hold an upper portion of a target leg of a user;
a lower leg holding assembly configured to hold a lower portion of the target leg of a user, and at least one of:
a flexion system configured to selectively move the target leg holding assembly in an arc about a first axis to thereby produce flexion or extension in a hip joint of the user's target leg;
a coronal rotation system configured to selectively move the target leg holding assembly in an arc about a second axis to thereby produce abduction or abduction in the hip joint of the user's target leg; and
a transverse rotation system configured to selectively move the lower leg holding assembly in an arc about a third axis to thereby produce internal rotation or external rotation in the hip joint of the user's target leg.

2. The device of claim 1, wherein at least one of the leg fixing assembly and the target leg motion assembly is connected to the base with a quick-release mount assembly.

3. The device of claim 1, wherein the leg fixing assembly and the target leg motion assembly are each connected to the base with a quick-release mount assembly.

4. The device of claim 1, wherein the flexion system includes a support member and a flexion actuator.

5. The device of claim 1, wherein the coronal rotation system includes a coronal rotation platform member and a coronal rotation actuator.

6. The device of claim 1, wherein the transverse rotation system includes an actuator support member and a transverse rotation actuator.

7. The device of claim 1, wherein the leg fixing assembly includes at least one locking highest, at least one leg fixing support member, and a foot engagement cradle.

8. The device of claim 1, wherein the leg fixing assembly extends in a horizontal direction in a use position.

9. The device of claim 1, wherein the leg fixing assembly has a portion extending in a vertical direction and a portion extending in a horizontal direction.

10. The device of claim 1, wherein the leg fixing assembly is configured to apply at least one of internal rotation and abduction to the user's non-target leg.

11. The device of claim 10, where the leg fixing assembly is pivotable relative to the base about a vertical axis.

12. The device of claim 1, wherein a height of the base is adjustable.

13. The device of claim 12, wherein the base includes one or more telescoping legs.

14. The device of claim 9, wherein the one or more telescoping legs each include a weight balancing device urging the telescoping leg towards an extended position.

15. The device of claim 1, wherein at least one of the actuators is a rotary actuator.

16. The device of claim 1, wherein at least one of the actuators is a hydraulic actuator.

17. The device of claim 12, further comprising a power unit mounted to the base, the power unit including: a power cylinder, a pivoting pump lever, and an adjustment switch.

18. The device of claim 12, further comprising a force application system mounted to the base, the power unit including: a pump, a pivoting pump lever, and an adjustment control.

19. The device of claim 1, further comprising a power unit including a powered pump operably connected to the actuators through a control.

20. The device of claim 1, wherein at least one of the target leg motion assembly and the leg fixing assembly is configured to pivot between a storage position and a use position.

21. The device of claim 1, wherein the base has a cradle to control the lower torso by limiting at least one of: pelvic rotation, abduction/adduction, or flexion/extension with a user supine.

22. The device of claim 1, wherein the base has a cradle to control the lower torso by limiting at least one of: pelvic rotation, abduction/adduction, or flexion/extension with a user standing.

23. The device of claim 1, wherein the base has a cradle to control the lower torso by limiting at least one of: pelvic rotation, abduction/adduction, or flexion/extension with the patient sitting up.

24. The device of claim 1, wherein the base has an extended portion that can slide under the mattress of a bed for stability.

25. The device of claim 1, wherein the base has a protruding handle to allow the user to pull themselves up into a seated position.

26. The device of claim 1, wherein the target leg holding assembly is attached to the base using a universal ball joint which allows three degrees of rotation of the target leg holding assembly with respect to the base.

27. The device of claim 26, wherein a linear actuator causes flexion/extension rotation.

28. The device of claim 26, wherein a linear actuator causes an abduction/adduction rotation.

29. The device of claim 26, wherein a linear actuator causes an internal/external rotation.

30. The device of claim 1, wherein the target leg cradle has a rotational actuator between the upper and lower leg at the knee that allows flexion and extension of the knee independently from any motion between the upper leg and the base.

31. The device of claim 1, wherein at least one actuator of the target leg motion assembly is are coupled with a measurement system including at least one transducer operable to measure a position of the target leg motion assembly.

32. The device of claim 31, wherein the measurement system includes a pressure transducer coupled to one of the actuators, where the actuator is hydraulically operated.

33. The device of claim 31, wherein the measurement system is connected in data communication to a computer.

34. The device of claim 33, wherein the computer is connected in data communication to a wide area network.

35. The device of claim 1, wherein the leg fixing assembly is configured with a pivoting connection to permit bending of a user's knee.
